(19) United States
(12) Patent Application Publication
(10) Pub. No.: US 2026/0119799 A1
(43) Pub. Date: Apr. 30, 2026

(54) AUDIENCE-DRIVEN INTERACTIVE TV / WEB SERIES CREATION USING NLP AND GENERATIVE AI

(71) Applicants: SOUMYA BARMAN, SNOHOMISH, WA (US); JOYANTA BANERJEE, SANTA CLARITA, CA (US)

(72) Inventors: SOUMYA BARMAN, SNOHOMISH, WA (US); JOYANTA BANERJEE, SANTA CLARITA, CA (US)

(21) Appl. No.: 18/928,010

(22) Filed: Oct. 26, 2024

(51) Int. Cl. G06F 40/30; G06F 40/284; G06Q 50/00

(52) U.S. Cl. CPC G06F 40/30; G06F 40/284; G06Q 10/40

(57) ABSTRACT

The disclosed embodiments provide techniques for generating scripts for TV/Web series using viewer feedback. The proposed system captures free form user input data from social media websites and streaming media platforms, including viewer comments and ratings. System uses advance techniques such as natural language processing (NLP) for sentiment and topic analysis and generative AI for content generation. A feedback loop with professional scriptwriters ensures the generated scripts are refined, polished and finalized with human oversight. Traditional methods of gathering viewer insights, such as ratings and surveys, often lack the ability to capture free form audience opinions and utilize the same to influence the future content development. This AI-driven approach significantly reduces the time and effort required by traditional scriptwriting methods while aligning entertainment content with audience preferences, fostering deeper audience involvement and satisfaction.

### TECHNICAL FIELD OF THE INVENTION

The field of this invention lies at the intersection of entertainment industry, artificial intelligence, and social media analytics. Specifically, the invention pertains to a system and method for generating scripts for television series or web series based on viewer feedback mined from social media platforms, in-app feedback processed through natural language processing (NLP) and Generative AI (Gen AI) algorithms.

### BACKGROUND OF INVENTION

The landscape of content generation is undergoing a transformative change as industry leaders like Amazon and Microsoft implement technologies aimed at automating and enhancing creative processes. Existing patents, such as Amazon's WO2024064522A1, concentrate on automating aspects of content generation within digital ecosystems, while Microsoft's U.S. Pat. No. 7,512,537-B2 introduces the use of natural language processing to dynamically create interactive movies and animated scenes. Meanwhile, US-20240303415-A1 from Microsoft and WO2019140120A1 from End Cue, LLC highlight developments in collaborative coauthoring and scriptwriting tools, which incorporate AI to facilitate content creation. Also, platforms like Wattpad and Episode allow users to influence storylines through comments and choices, but these don't auto-generate new content based on user's feedback.

Despite these innovations, current technologies encounter challenges in assimilating real-time viewer feedback into the storytelling process. Traditional methods of gathering feedback include viewer ratings, focus groups, and surveys. However, these methods often fail to capture the real-time, nuanced, diverse opinions of the audience and feeding the feedback into the future content. In recent years, the advent of social media platforms such as Twitter, Facebook, Instagram, and Reddit have revolutionized the way viewers interact with content creators. These platforms provide a continuous stream of unsolicited, candid, and rich feedback from a broad audience. Steaming platforms such as Netflix and Amazon Prime don't provide capability to capture free form viewer feedback to influence the future storylines. Many of these solutions rely on structured data and require significant manual intervention to interpret unstructured audience inputs, such as comments or social media interactions. This results in delays, increased potential for bias, and a disconnect between what audiences want and what is delivered.

This invention addresses these issues with a comprehensive platform that uniquely integrates cutting-edge natural language processing and AI-driven viewer feedback analysis. This system processes unstructured viewer feedback in real-time, transforming it into actionable insights that can directly influence script and storyline development. Unlike previous systems that require manual oversight, our invention automatically collects and analyzes viewer feedback from various digital sources, such as streaming platforms and social media, using advanced sentiment analysis to gauge audience reactions and preferences accurately.

The invention employs a robust AI engine that uses the processed feedback to suggest script modifications or enhancements, allowing for dynamic adaptation of content to align with viewer expectations. This real-time adaptability ensures that content remains engaging and relevant. While current tools provide basic AI assistance for coauthoring, our invention enhances this by allowing seamless collaboration between human writers and AI systems. Writers can harness AI-generated drafts, ensuring room for creativity while also benefiting from feedback-informed suggestions.

Additionally, by directly incorporating viewer preferences into the creative process, viewers feel a deeper sense of participation and investment in the content, which can lead to increased viewership and loyalty.

This invention represents a breakthrough in crafting creative content, effectively bridging the gap between creators and consumers in the entertainment industry. By overcoming the limitations of existing patents through real-time responsiveness and automated content adaptation, the invention paves the way for a more interactive and responsive storytelling approach, setting a new standard for content generation in an increasingly digital world.

### SUMMARY OF THE INVENTION

The invention transforms the traditional scriptwriting process for television and web series by harnessing the power of artificial intelligence (AI) and viewer feedback. This system offers a cutting-edge approach to content creation, addressing key challenges such as the volume and complexity of feedback and the need for real-time insights to inform storytelling. It leverages advanced AI algorithms and cloud-based infrastructure to create scripts that resonate with audiences, enhancing engagement and satisfaction.

At the heart of the system is a robust data ingestion module, designed to collect diverse forms of viewer feedback from streaming media and social media platforms. This feedback, which includes comments, ratings, and interaction data, discussions etc. undergoes cleansing to ensure relevance and appropriateness. Processed data is stored in a scalable cloud-based storage services, providing a structured foundation for further analysis.

The system employs a sentiment analysis module powered by natural language processing (NLP) to categorize viewer feedback into sentiments and emotions, such as positivity, negativity, or neutrality. This facilitates a deeper understanding of the audience's emotional responses to content. Further, a topic analysis module identifies key themes and plot points generating viewer interest, providing critical insights into audience preferences.

A unique feature of this invention is its embedding creation module, which generates vector embeddings from analyzed data and past scripts using large language models. These embeddings enable the integration of feedback insights into the generative AI scriptwriter module, where the magic of script generation occurs. Here, generative AI algorithms draft preliminary scripts that seamlessly blend existing storylines with new developments inspired by viewer-derived insights.

Professional scriptwriters review the AI-generated drafts, ensuring a balance between automated content creation and human creativity. Feedback from these experts'forms part of an iterative loop, refining the scripts to capture nuanced human emotions and narrative depth. This feedback loop continues until a polished and audience-aligned script is achieved.

By automating the analysis of vast quantities of viewer feedback and using it as a creative input for scriptwriting, the invention significantly reduces the time and effort traditionally required by human writers. It allows for the rapid development of scripts that are more aligned with audience tastes, consequently boosting viewer engagement and loyalty. This forward-thinking approach to scriptwriting marks a significant shift in how television and web series content is produced, fostering truly interactive storytelling experiences that elevate viewer involvement to new heights.

### BRIEF DESCRIPTION OF DRAWINGS

FIG. 1 illustrates the overall system flowchart, detailing the sequential modules from viewer feedback ingestion to script finalization.

FIG. 2 depicts the data ingestion module, highlighting the steps of capturing viewer feedback from social media and streaming media platforms, cleansing, and storing viewer feedback.

FIG. 3 outlines the sentiment analysis module, showcasing how feedback is classified using natural language processing and machine learning.

FIG. 4 represents the topic analysis and clustering module, explaining how feedback is organized into thematic clusters.

FIG. 5 shows the embedding creation module, where vector embeddings are generated using large language GPT models from viewer sentiment data and previous scripts.

FIG. 6 illustrates the script generation module, detailing the process of generating script drafts using generative AI and refining them with human input.

FIG. 7 shows the in-app viewer comment and questions interface, which facilitates engagement and captures viewer input for future content generation.

### DETAILED DESCRIPTION

The invention is a system designed to automate the scriptwriting process by integrating viewer feedback into script development, thereby creating content that aligns more closely with audience preferences. The system leverages various cloud-based services for storage, compute, artificial intelligence (AI), and machine learning (ML) techniques to efficiently analyze and utilize audience insights. The primary objective of the invention is to expedite the script generation process and increase engaging viewership for TV/Web series. The subject invention is described below with reference to the drawings, wherein like reference numerals are used to refer to like elements throughout. In the following description, for purposes of explanation, numerous specific details are set forth to provide a thorough understanding of the subject invention. It may be evident, however, that the subject invention may be practiced without these specific details. In other instances, well-known structures and devices are shown in block diagram form to facilitate describing the subject invention.

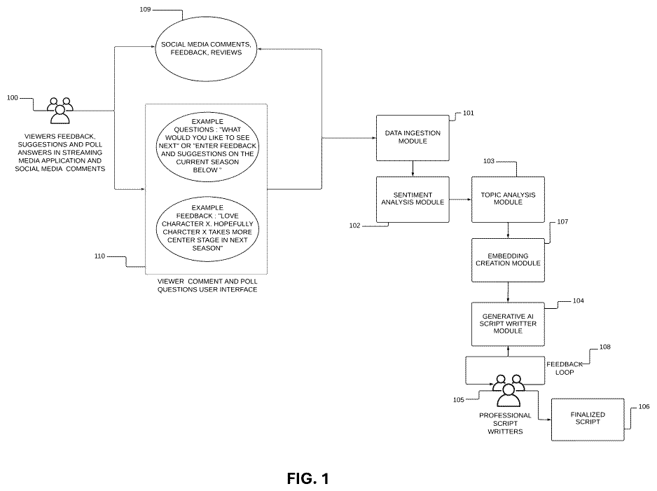

FIG. 1 The system initiates with viewers 100 submitting feedback, suggestions, and answering questions like “Enter feedback and suggestions on the current season below” or “what would you like to see next” in the streaming media application (example—Netflix, Amazon Prime) user interface 110. Also, viewers 100 submit comments and reviews in various social media platforms 109. This input is first processed by the data ingestion module 101, which compiles and organizes the collected data for analysis. Following this, the sentiment analysis module 102 examines the feedback to gauge the sentiment regarding characters and plot lines. For example, viewer comments such as “love character x. hopefully character x takes more center stage in next season” help determine positive perceptions. Subsequently, the topic analysis module 103 analyzes the input to extract common topics and themes from the feedback data. This allows identification of key areas of interest among viewers. The data then moves to the embedding creation module 107, where it is converted into embeddings—numerical representations of the data and stored in a vector database, that can be utilized effectively by the next module. The generative AI script writer module 104 utilizes these embeddings to create initial script drafts, incorporating the analyzed viewer interests and sentiments. These drafts are then passed along to professional script writers 105 who refine and enhance the scripts, ensuring alignment with creative goals and viewer expectations. The content passes through feedback loop to continually assess and improve the content. After several cycles between generative AI script writer module 104 and script writers 105, polished and approved script is finalized 106.

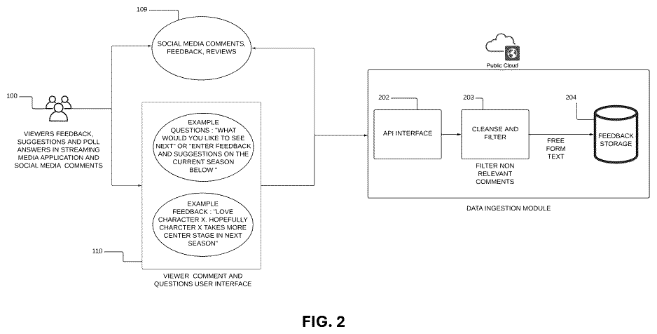

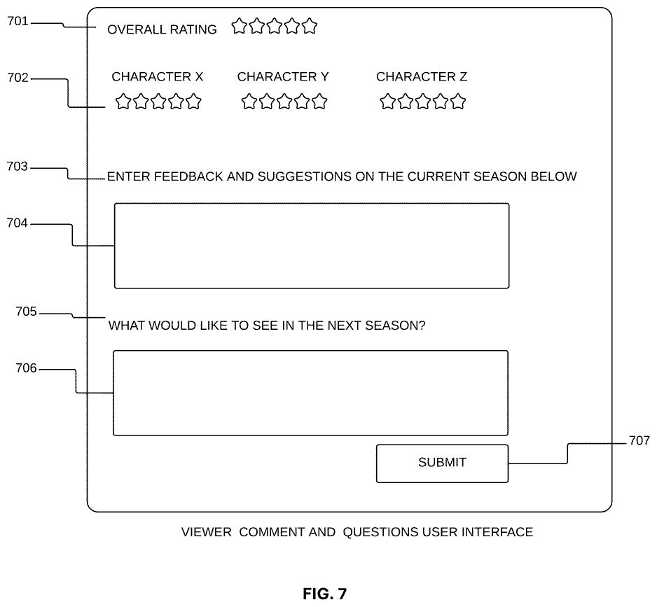

FIG. 2 In the process, viewers 100 submit feedback, suggestions, and answer questions, such as “Enter feedback and suggestions on the current season below” or “what would you like to see next”. This step begins with the viewer feedback collection in-app user interface 110 (FIG. 7), enabling viewers to provide input directly through the app. Also, viewers 100 submit comments, reviews directly in social media platforms (example—Facebook, Reddit etc.) 109. Data ingestion module collects all the user input using APIs from social media platforms. Also, the in-app user interface 110, utilizes the API interface 202 to send user input to the data ingestion module, which facilitates the transfer of data from the app to the backend systems. The data then undergoes a cleanse and filter operation 203 to remove non-relevant, offensive comments ensuring that only pertinent feedback is retained. The relevant feedback is stored as free form text in the cloud-based feedback storage component 204. All these steps collectively form the data ingestion module 101 depicted in FIG. 1. All the storage, compute components are deployed to public cloud platform such as Amazon Web Services.

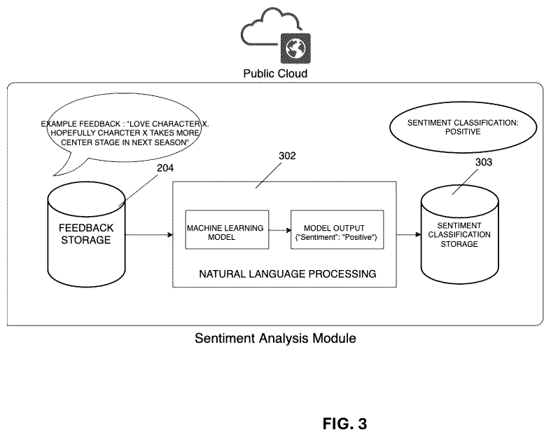

FIG. 3 The sentiment analysis module operates within the public cloud infrastructure to process feedback and gauge viewer sentiment. Taking the example feedback, “love character x. hopefully character x takes more center stage in next season,” we see the process unfold as follows. Initially, the feedback, such as this positive comment about character x, is retrieved from feedback storage 204. From there, it proceeds to natural language processing 302, where the text is analyzed to understand its emotional tone and context. This stage involves applying a machine learning model, which has been trained to discern sentiment from text data. The model evaluates the feedback to determine whether it reflects positive, negative, or neutral feelings. The output of the model, which classifies the sentiment of the analyzed feedback, is then stored in the sentiment classification storage 303. This classification helps in understanding general viewer sentiment towards characters and plot developments, aiding decisions in script development and adjustment.

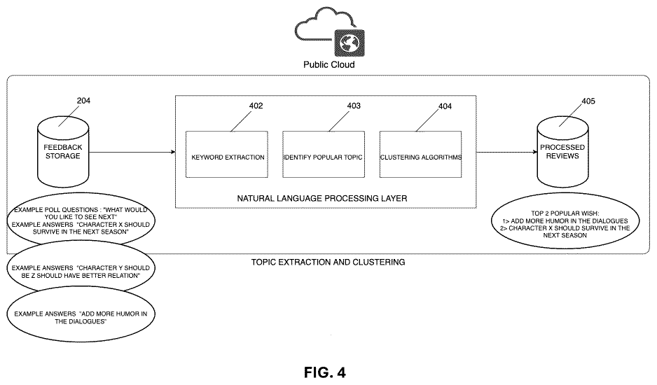

FIG. 4 The extraction and clustering process begins with feedback storage 204, where viewer feedback is initially held. This data proceeds to the natural language processing layer, where it undergoes several analytical steps. The first step within this layer is keyword extraction 402. Here, essential words and phrases are identified from the feedback, highlighting significant topics of discussion among viewers. Next, the process moves to identify popular topics 403, which involves determining the most frequently mentioned subjects or themes within the feedback. This step helps in understanding which topics capture the most interest or concern from the audience. Following this, clustering algorithms 404 are applied to group similar topics or feedback together, allowing for the organization of data into coherent clusters. This step ensures that related feedback is aggregated, facilitating easier analysis and decision-making. Finally, this series of steps results in processed reviews 405 that are stored in cloud storage, where the extracted keywords and clustered topics present a clear and organized view of viewer feedback, aiding in content strategy and planning.

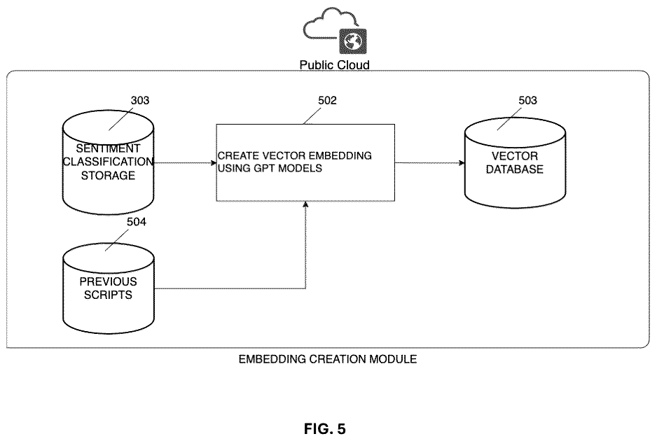

Depicted in FIG. 5, the embedding creation module initiates the process by integrating sentiment classification storage 303 and previous scripts 504 as inputs. These components provide crucial contextual and historical data that assist in understanding the nuances of viewer feedback and content performance. The system then employs large language GPT models 502 to transform these inputs into vector embeddings. This step creates a rich, multidimensional representation of the data, capturing intricate patterns and relationships inherent in the feedback and script content. The resulting vector embeddings are then stored in the vector database 503 in cloud platform such as Amazon OpenSearch Service. This database serves as an input prompt for the script generation module.

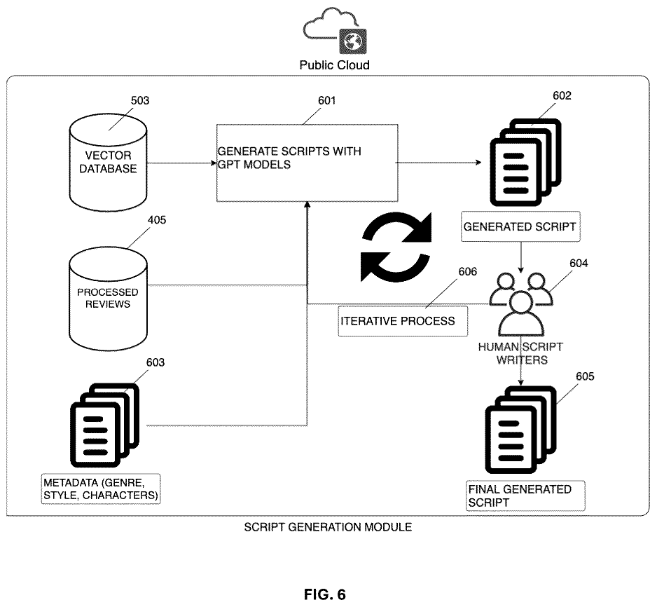

As shown in FIG. 6, the script generation module operates within a cloud-based environment to enhance flexibility and scalability in processing. The process begins with inputs from the vector database 503, which contains rich embeddings generated from previous scripts 504 and data stored in sentiment classification storage 303. Alongside, processed reviews 405 and metadata 603 such as genre, style etc. are provided as input to the script generation GPT model 601 to provide context and additional layers of information regarding previous scripts, themes, plot requirements, viewer feedback and character dynamics. The large language GPT model 601, generated the draft scripts 602, leveraging the intricate understanding encoded in the vector embeddings and the supplementary data mentioned earlier. An iterative process 606 runs to refine these drafts, enabling continuous improvement and alignment with creative goals through repeated feedback and modification cycles between the human script writers 604 and large language GPT model 601. In this iterative refinement, the drafts are each reviewed and further polished by human script writers 604. This human oversight ensures that the final generated scripts 605 align with artistic vision and maintain quality standards before finalized approved script is produced.

In FIG. 7, the viewers comment, and questions interface is designed to collect comprehensive feedback and engage audience participation. The user interface has an overall rating section 701, allowing viewers to provide a summary score of their experience with the content. This serves as a quick reference to gauge general satisfaction. Following the overall rating, there are sections specifically dedicated to character feedback 702, where viewers can express their thoughts on characters x, y, and z. This allows for targeted insights into the performance and development of key characters. Viewers are then encouraged to enter detailed feedback and suggestions on the current season 703. This section is crucial for gathering nuanced opinions and recommendations for content improvement. An empty space 704 is provided to input free form text as an answer to question 703, ensuring that viewers have the freedom to provide their feedback. The interface also prompts viewers with “what would you like to see in the next season?” 705, inviting them to share their hopes and expectations for future season developments. Empty space 706 is available for providing viewer's creative suggestions related to the upcoming season. Finally, viewer submits their feedback by clicking on the submit button 707. The feedback is submitted to the data ingestion module 101 for further analysis and storage. This structure ensures that viewer feedback is thorough and multifaceted.

This carefully orchestrated system facilitates a novel approach to content generation, aligning it closely with audience preferences while ensuring creative refinement through the interplay of AI-driven and human approved methodologies. For a comprehensive understanding of each process stage, please refer to the accompanying figures and their respective detailed module descriptions.

The entire system is implemented on a public cloud platform equipped with necessary infrastructure, storage, and AI/ML services. It leverages the scalability, flexibility, and computational power of cloud services to handle varying volumes of viewer feedback in real-time, delivering timely insights and actionable script drafts.

This invention marks a significant advancement in interactive content creation, transforming the traditional scriptwriting process into a dynamic, audience-driven experience. By continuously analyzing real-time viewer feedback and adapting scripts accordingly, the system fosters a deeper connection between audiences and content, enhancing viewer satisfaction and loyalty. This automated, feedback-driven scriptwriting process not only streamlines content creation but also ensures the production of relevant and engaging entertainment tailored to audience preferences. This technology could shift the paradigm of how television and web series content is developed, offering a new model of viewer engagement and participation.

1. A TV/Web series script generation system from viewer feedback comprising:
a. a user interface to collect viewer rating, feedback and suggestions for future season
b. a data ingestion module designed to gather unstructured viewer feedback from multiple sources, including streaming platforms, social media, and other digital channels via APIs.
c. a cleansing and data filtering process for removing irrelevant content and noise from the collected data.
d. a natural language processing (NLP) system for analyzing viewer sentiment and trending topics
e. a vector embedding system
f. a script generation system comprising generative AI models and human script writers
g. a feedback loop between human script writer and script generation system
h. a cloud-based compute, storage, natural language processing (NLP) and generative AI services.

2. The system of claim 1, wherein the natural language processing (NLP) component performs of sentiment analysis, topic and keyword extraction, tokenization, clustering and text summarization.

3. The system of claim 1, wherein the script generation component comprises of a Generative Pre-Trained Transformer 4 model, that includes feedback from human scriptwriter in an iterative manner.
